(19) United States
(12) Patent Application Publication
(10) Pub. No.: US 2017/0011353 A1
(43) Pub. Date: Jan. 12, 2017

(54) CALENDAR ENTRY INDICATION ACROSS CALENDAR SERVICES

(71) Applicant: Consortia, Inc., San Francisco, CA (US)

(72) Inventor: Isaiah C. Weiner, Berkeley, CA (US)

(21) Appl. No.: 15/205,328

(22) Filed: Jul. 8, 2016

Related U.S. Application Data
(60) Provisional application No. 62/190,128, filed on Jul. 8, 2015.

(51) Int. Cl. G06Q 10/10

(52) U.S. Cl. CPC G06Q 10/1095

(57) ABSTRACT

Embodiments disclosed herein provide systems, methods, and computer readable media for indicating calendar entries across a plurality of calendar services. In a particular embodiment, a method provides identifying at least one calendar entry for a first calendar of a first calendar service of the plurality of calendar services. The method further provides converting the at least one calendar entry into at least one placeholder calendar entry for a second calendar of a second calendar service of the plurality of calendar services and inserting the at least one placeholder calendar entry into the second calendar.

### RELATED APPLICATIONS

This application is related to and claims priority to U.S. Provisional Patent Application 62/190,128, titled “CALENDAR ENTRY INDICATION ACROSS CALENDAR SERVICES,” filed Jul. 8, 2015, and which is hereby incorporated by reference in its entirety.

### TECHNICAL BACKGROUND

Many people use computer calendar services to organize their daily lives. These calendar services may be accessed via one or more devices that a user may have, such as their cellphone, laptop, or tablet. In many cases, a centralized system hosting a calendar service is able to ensure a user's calendar is synchronized across multiple devices. Some people use more than one calendar service in order to track different types of events. For example, work events may be tracked using entries in a calendar for a calendar service provided by a user's employer while personal events are tracked using entries in a calendar for a calendar service that the user subscribes to on their own. Given multiple calendar situations like the preceding example, entries in one calendar are not reflected in the others, which may cause confusion to a user when trying to make sure events in one calendar don't conflict with events in another.

### OVERVIEW

Embodiments disclosed herein provide systems, methods, and computer readable media for indicating calendar entries across a plurality of calendar services. In a particular embodiment, a method provides identifying at least one calendar entry for a first calendar of a first calendar service of the plurality of calendar services. The method further provides converting the at least one calendar entry into at least one placeholder calendar entry for a second calendar of a second calendar service of the plurality of calendar services and inserting the at least one placeholder calendar entry into the second calendar.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a multiple calendar environment in an example embodiment.

FIG. 2 illustrates a method of operating the multiple calendar environment in an operational scenario.

FIG. 3 illustrates an operational scenario of indicating events across calendars.

FIG. 4 illustrates an operational scenario of indicating events across calendars.

FIG. 5 illustrates an operational scenario of indicating events across calendars.

FIG. 6 illustrates a multi-service calendar system in an example embodiment.

### DETAILED DESCRIPTION

Many calendar services exist that allow users to maintain their schedules on computing devices, such as cellphones, tablets, personal computers, and the like. Examples types of these services include Microsoft Exchange, Google Calendar, and Yahoo! Calendar, among many others. Each of these services may include different features for calendar entries and may be accessed using different protocols. A single user may access calendars maintained by different calendar services. For example, a user may have calendars maintained in multiple Exchange services (e.g. accounts) for different jobs, respectively, and a calendar on a Google Calendar service for personal events. When viewing the calendar(s) in one of the multiple Exchange services, the user may not be able to concurrently view entries in calendars in the other Exchange services or entries in the Google Calendar service on the same calendar view. In these situations, the user may need to switch between calendar applications or calendars within the same calendar application, if either of these actions are feasible or allowed on the user's device, to piece together events from each calendar in order to get an overall understanding of the user's schedule. In contrast, the multi-calendar system discussed below allows a user to view events from multiple calendar services in a single calendar.

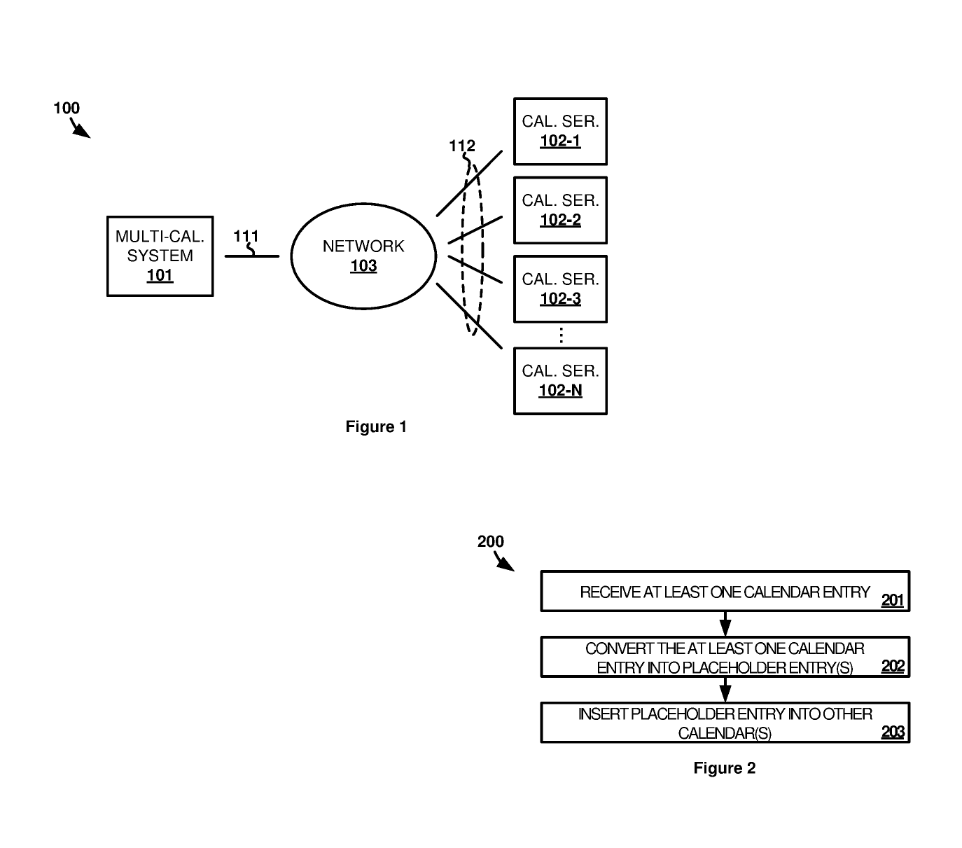

FIG. 1 illustrates multiple calendar environment 100 in an example embodiment for indicating calendar entries across a plurality of calendar services. Multiple calendar environment 100 includes multi-calendar system 101, calendar services systems 102, and communication network 103. Multi-calendar system 101 and communication network 103 communicate over communication link 111. Calendar service systems 102 and network 103 communicate over communication links 112.

In operation, calendar service systems 102 provide calendar services to user systems, such as cellphones, tablets, personal computers, and the like. The calendar services may be accessed using an application executing on a user system (e.g. a cellphone calendar application). The calendar services described herein may refer to distinct calendar services even if the services are of the same type or are provided by the same calendar service system 102. For example, a user may have multiple accounts for accessing Google Calendar services and each of these multiple Google Calendar accounts may be considered different calendar services even if the same service system hosts calendars for both accounts.

Multi-calendar system 101 comprises any type of computer system capable of accessing calendar service systems 102. In some cases, multi-calendar system may be a purpose built computer system (e.g. server) configured to operate as described below. In other cases, the functionality of multi-calendar system 101 may be implemented using an application executing on a user's device (e.g. cellphone, laptop, etc.). In some cases, at least one of the calendar services may be hosted by multi-calendar system 101 itself rather than one of calendar service systems 102.

FIG. 2 illustrates method 200 of multiple calendar environment 100 for indicating calendar entries across a plurality of calendar services. In this example, each calendar service corresponds to an individual calendar service system 102, although, a calendar service system 102 may provide more than one calendar service. Method 200 provides multi-calendar system 101 receiving at least one calendar entry for a first calendar of a first calendar service (step 201). In this example, calendar service system 102-1 provides the first calendar service. In order to access the first calendar service, along with any other calendar services, multi-calendar system 101 may be provided with access credentials (e.g. username and password) used to access the service. For example, a user may provide multi-calendar system 101 with the access credentials for any calendar service to which the user wants multi-calendar system 101 to have access.

The at least one calendar entry may be received from calendar service system 102-1 as an entry already entered into the first calendar. Alternatively, the at least one entry may be entered by a user of multi-calendar system 101 into the first calendar, as may be the case if multi-calendar system 101 is also a user system that the user operates to access the first calendar.

Method 200 then provides multi-calendar system 101 converting the at least one calendar entry into at least one placeholder calendar entry for a second calendar of a second calendar service provided, in this example, by calendar service system 102-3 (step 202). Converting the at least one calendar entry may include reformatting the at least one calendar entry into a format required by the second calendar service, if different from the format required by the first calendar service. In some cases, if the second calendar service is the same type of service (e.g. Exchange) as the first calendar service, then the placeholder calendar entry may be a direct copy of the at least one calendar entry. Some calendar services allow users to block off time as not being available. The placeholder entries in those cases may be implemented as blocked off times rather than calendar entries.

Additionally, multi-calendar system 101 may modify the at least one placeholder entry to account for the fact that it is based on entries in another calendar. The modifications may include any event parameters allowed by the second calendar service such as entry title, start/end times, travel time, event location, notes, location, etc. For example, the first calendar service may automatically account for travel time to a location and the second calendar service may not. Thus, multi-calendar system 101 may modify the start/end times for the placeholder entry to cover travel time that would not have otherwise been accounted for by the second calendar service. The way in which a placeholder entry is modified may depend on user preferences assigned by the user. For example, the user may indicate whether they want the placeholder to simply block off a section of time corresponding to the original entry from the first calendar or want the placeholder to provide more details about the original entry from the first calendar, such as the title, location, or otherwise.

Once the at least one placeholder entry is generated from the conversion, method 200 provides multi-calendar system 101 inserting the at least one placeholder calendar entry into the second calendar (step 203). The insertion of the at least one placeholder entry into the second calendar may occur locally at multi-calendar system 101 before being synchronized with calendar service system 102-3 or may be inserted directly into the second calendar at calendar service system 102-3 at the instruction of multi-calendar system 101.

After the at least one placeholder entry is inserted into the second calendar, the user will see the at least one placeholder entry as an entry in the second calendar. In some examples, the modifications to the at least one placeholder entry may indicate to the user that it is a placeholder entry from another calendar rather than one originally entered into the second calendar. In other examples, the at least one placeholder entry may simply block off times in the second calendar without necessarily providing any further details. Regardless of its appearance, the placeholder entry allows the user to view the second calendar and immediately locate open time slots in their schedule without having to also look at the first calendar.

It should be understood that, while the example above only refers to two calendars of two calendar services, the at least one entry may be converted to placeholder entries across any number of calendars or calendar services. For example, in addition to the at least one placeholder entry, the at least one entry from the first calendar may be converted to at least one placeholder entry in a third calendar of a third calendar service hosted by calendar service system 102-2 for insertion therein. Likewise, entries in other calendars may be converted and inserted into the first calendar to ensure all entries are reflected across all of the user's calendars, or at least calendars designated by the user.

Additionally, when multi-calendar system 101 is initially used to perform method 200 on a user's calendars, then multi-calendar system 101 may have to generate placeholders across all calendars specified by the user. This initial run through of method 200 may encompass all entries stored in each calendar, just entries for future times, or some portion thereof. After system initiation, multi-calendar system 101 may be configured to run method 200 periodically, upon detecting new calendar entries, or on some other schedule.

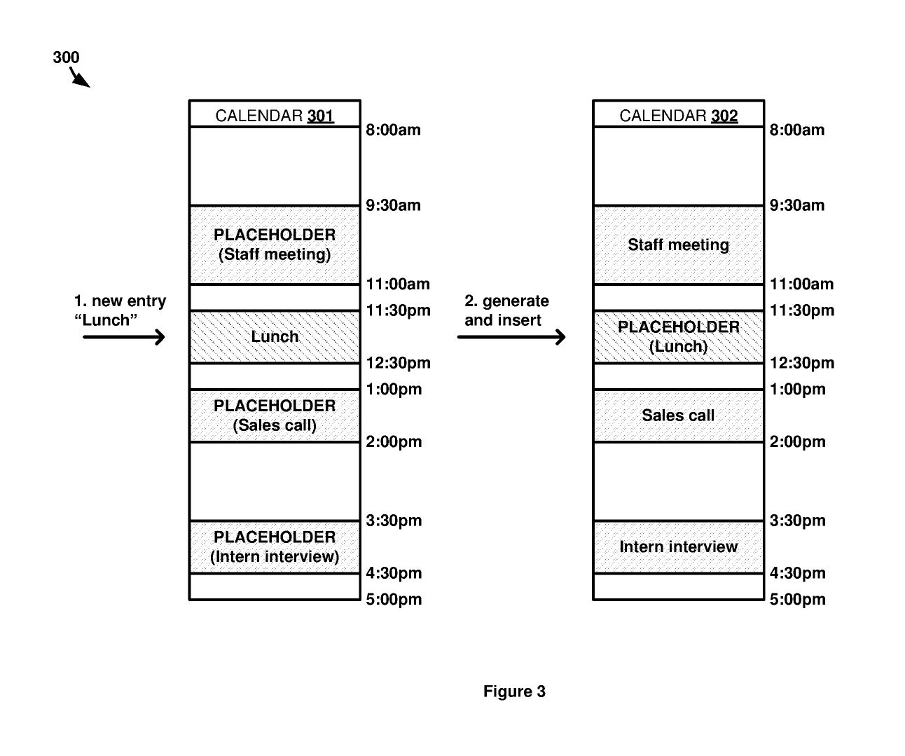

FIG. 3 illustrates operation 300 in an example scenario for indicating calendar entries across a plurality of calendar services. For simplicity, this example only uses two calendars across two calendar services and is limited to a single day view in each calendar from 8:00 am to 5:00 pm. The views of calendars 301 and 302 illustrated in operation 300 are an example of what a user may be presented with on a display screen when viewing either calendar. Before operation 300, placeholder entries have been placed into calendar 301 based on events from calendar 302. In this example, the placeholder entries further indicate what entry in calendar 302 each place holder corresponds. For instance, calendar 302 is a user's work calendar in a calendar service provided by the user's employer and shows that a staff meeting is scheduled from 9:30 am to 11:00 am. A corresponding placeholder in calendar 301, which is the user's personal calendar in another calendar service, blocks off 9:30 am to 11:00 am while indicating that the placeholder corresponds to the staff meeting entry.

The placeholders in calendar 301 allow the user to easily view what times are available for scheduling an event in calendar 301 without having to look at calendar 302 as well. In this example, the user wants to schedule a personal lunch into their personal calendar 301. The placeholders corresponding to events in the user's work calendar 302 indicate to the user times in which other events are scheduled without the user having to view work calendar 302. The user decides that lunch can take place between 11:30 am and 12:30 pm and, at step 1, enters an entry for “Lunch” into personal calendar 301.

Multi-calendar system 101 receives this new entry for “Lunch” and, at step 2, converts the entry into a placeholder entry for work calendar 302 and inserts the placeholder entry into calendar 302. Accordingly, when the user views work calendar 302, work calendar 302 displays the placeholder entry for “Lunch” as inserted into calendar 302 without having to look back at personal calendar 301.

Referring back to FIG. 1, multi-calendar system 101 comprises a computer system and communication interface, which are configured to access calendar service systems 102. Multi-calendar system 101 may also include other components such as a router, server, data storage system, and power supply. Multi-calendar system 101 may reside in a single device or may be distributed across multiple devices. Multi-calendar system 101 may be a telephone, tablet, personal computer, gaming system, media player, or some other computing system—including combinations thereof.

Calendar service systems 102 each comprises a computer system and communication interface, which are configured to supply a calendar service to other systems or devices. Calendar service systems 102 may also include other components such as a router, server, data storage system, and power supply. Calendar service systems 102 may each reside in a single device or may be distributed across multiple devices.

Communication network 103 comprises network elements that provide communications services. Communication network 103 may comprise switches, wireless access nodes, Internet routers, network gateways, application servers, computer systems, communication links, or some other type of communication equipment—including combinations thereof.

Communication links 111-112 could be internal system busses or use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 111-112 could be direct links or may include intermediate networks, systems, or devices.

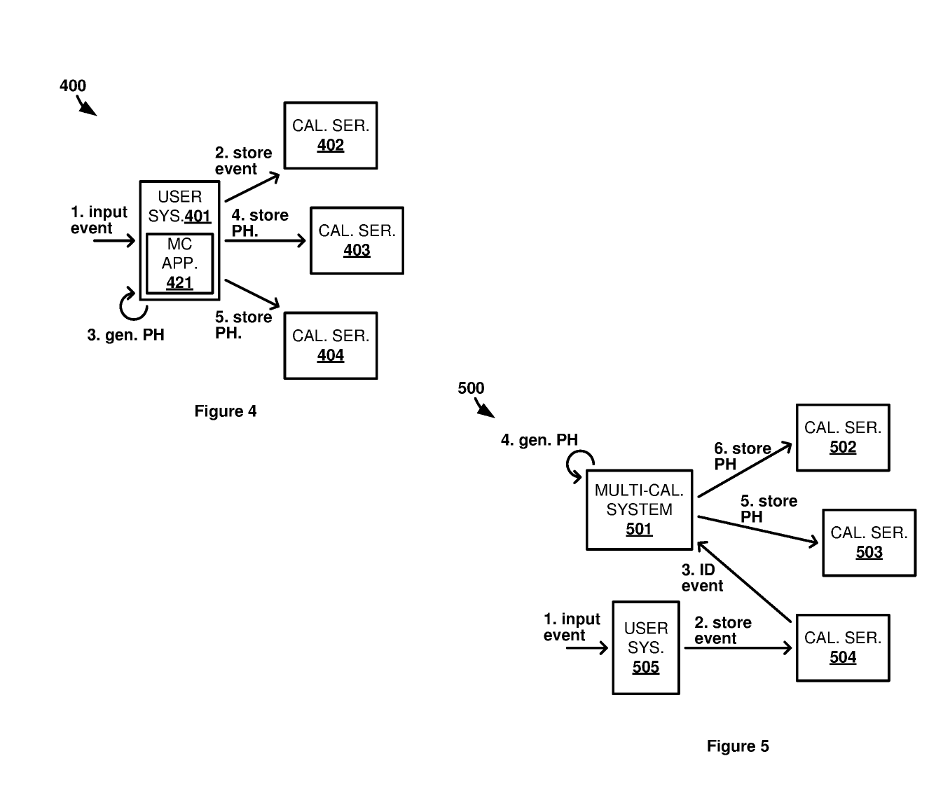

FIG. 4 illustrates operational scenario 400 for indicating calendar entries across a plurality of calendar services. Scenario 400 includes user system 401 and calendar service systems 402-404. Though not shown, systems 401-404 may exchange communications over one or more communication networks similar to communication network 103. In this example, a multi-calendar system is implemented with user system 401 through the execution of multi-calendar application 421 on user system 401. User system 401 may be a smartphone, tablet, personal computer (e.g. laptop, desktop, or otherwise), or some other sort of computing system operated by a user. Multi-calendar application 421 may come preinstalled on user system 401, a user of user system 401 may direct user system 401 to download and install multi-calendar application 421 from an application store, or multi-calendar application 421 may come to be installed on user system 401 in some other manner.

Scenario 400 describes a process where a new calendar event is entered into a calendar hosted by calendar service system 402, although the same steps may be applied to an event entered into either of the other calendar service systems. The user of user system 401 has access to that calendar in addition to calendars hosted by calendar service system 403 and calendar service system 404 (e.g. through user accounts with each of systems 402-404). Method 200 may have already been performed on the three calendars to create placeholders for already created events and scenario 400 may therefore be an example of how method 200 handles new events being entered. In scenario 400, a user of user system 401 inputs a new calendar event entry into user system 401 at step 1. The new event entry in this example is an event for a calendar hosted by calendar service system 402. The new event entry may be input into an interface of multi-calendar application 421 if multi-calendar application 421 includes a calendar access interface. Alternatively, the new event entry may be input into an interface for another calendar application executing on user system 401. In those cases, multi-calendar application 421 may run in the background on user system 401, or otherwise interact with that calendar application, to identify that a new event entry was created from the input of the user of user system 401. The new calendar entry can be stored as is to calendar service system 402 at step 2 since it was originally intended for a calendar hosted by calendar service system 402. If the event was entered into a calendar application, that application directs user system 401 to store the entry on calendar service system 402. However, if the event was input into multi-calendar application 421, then multi-calendar application 421 may direct user system 401 to store the entry on calendar service system 402.

At step 3, multi-calendar application 421 directs user system 401 to generate placeholder calendar entries for storage on calendar service system 403 and calendar service system 404, respectively. The placeholders are meant to at least block off a time frame corresponding to the new event in calendars hosted by calendar service system 403 and calendar service system 404. The placeholders may also provide additional details about the event, such as the calendar where the event originated, a title of the event, a location of the event, or any other type of information that may be relevant (if such information was included in the original event parameters). If either of calendar service system 403 and calendar service system 404 support the ability to simply block off time in a calendar, then the placeholder for that calendar may comprise simply instructing calendar service system 403 or calendar service system 404 to block off the time corresponding to the new calendar event. If either of calendar service system 403 and calendar service system 404 support the same format for calendar entries, then the placeholder may simply be a duplicate copy of the calendar entry.

However, it is also possible that calendar service system 403 and calendar service system 404 do not support the same format. In those cases, multi-calendar application 421 will map information in elements of the calendar event to corresponding elements of the placeholder for calendar service system 403 and/or calendar service system 404. For example, calendar service system 402 may include a notes field for notes about the event while calendar service system 403 has a details field that multi-calendar application 421 determines corresponds to the notes field. In some cases, there may not be a corresponding element in calendar service system 403 and/or calendar service system 404. In those cases, multi-calendar application 421 may need to adjust the information when no direct correspondence exists between elements. For instance, as noted in an example above, calendar service system 402 may support travel times while calendar service system 403 does not. The travel time information may therefore have to be adjusted into the event time itself when creating the placeholder for calendar service system 403. A user may provide preferences for how multi-calendar application 421 should handle various situations where no corresponding element exists.

It should be understood that calendar events in calendars hosted by calendar service system 403 and calendar service system 404 may use the same or different formats and, therefore, the placeholders generated for calendar service system 403 and calendar service system 404 may be different. Regardless, at steps 4 and 5, multi-calendar application 421 directs user system 401 to store the respective placeholder events in calendars hosted by calendar service system 403 and calendar service system 404. Once the placeholders have been stored, viewing any one of the user's calendars individually will show the placeholder events. For example, someone looking to schedule a meeting with the user in the user's work calendar will be able to see the time for a doctor's appointment from the user's personal calendar blocked off so that the meeting cannot be scheduled during that time.

FIG. 5 illustrates operational scenario 500 for indicating calendar entries across a plurality of calendar services. Scenario 500 includes multi-calendar system 501, calendar service systems 502-504, and user system 501. Though not shown, systems 501-505 may exchange communications over one or more communication networks similar to communication network 103. In this example, a multi-calendar system is implemented in a system remote to user system 505. However, user system 505 may be used by a user to configure multi-calendar system 501 to access calendars of the user that are hosted by calendar service systems 502-504. In one example, multi-calendar system 501 may host a website through which the configuration can be performed, although other configuration mechanisms, such as a configuration application on user system 505, may also be used. Like user system 401 from above, user system 501 may comprise a smartphone, tablet, personal computer (e.g. laptop, desktop, or otherwise), or some other sort of computing system operated by a user.

Scenario 500 describes a process where a new calendar event is entered into a calendar hosted by calendar service system 504 although the same steps may be applied to an event entered into either of the other calendar service systems. The user of user system 505 has access to that calendar in addition to calendars hosted by calendar service system 502 and calendar service system 503 (e.g. through user accounts with each of systems 502-503). Method 200 may have already been performed on the three calendars by multi-calendar system 501 to create placeholders for already created events and scenario 500 may therefore be an example of how method 200 handles new events being entered.

In scenario 500, a user of user system 505 enters a new event into the calendar hosted by calendar service system 504 at step 1 and that event is stored in calendar service system 504. The event may be entered via a calendar application running on user system 505, through a website hosted by calendar service system 504, or by some other means. Multi-calendar system 501 identifies the event at step 3. Multi-calendar system 501 may identify the event by being automatically notified of the event by calendar service system 504, may poll calendar service system 504 for updates to the calendar (may also poll systems 502 and 503 for updates to those calendars similarly), or may receive the event information in some other manner.

Once multi-calendar system 501 has identified the new event, multi-calendar system 501 generates placeholder events for the calendars hosted by calendar service system 502 and calendar service system 503 at step 4. The generation of the placeholder events is performed in a similar manner to the generation of the placeholder events described with respect to step 3 of scenario 400 above. The generated placeholder events are then stored in the calendars of respective calendar service systems 502 and 503 at steps 5 and 6. Thus, the results of scenario 500 are similar to those of scenario 400 but do not rely on a user device to be performed.

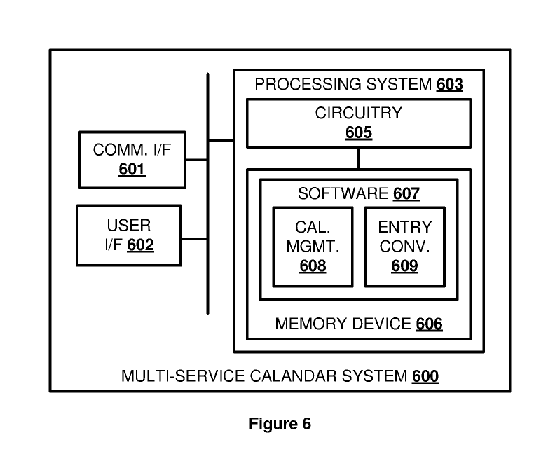

FIG. 6 illustrates multi-calendar system 600. Multi-calendar system 600 is an example of multi-calendar system 101, although system 101 may use alternative configurations. Multi-calendar system 600 comprises communication interface 601, user interface 602, and processing system 603. Processing system 603 is linked to communication interface 601 and user interface 602. Processing system 603 includes processing circuitry 605 and memory device 606 that stores operating software 607.

Communication interface 601 comprises components that communicate over communication links, such as network cards, ports, RF transceivers, processing circuitry and software, or some other communication devices. Communication interface 601 may be configured to communicate over metallic, wireless, or optical links. Communication interface 601 may be configured to use TDM, IP, Ethernet, optical networking, wireless protocols, communication signaling, or some other communication format—including combinations thereof.

User interface 602 comprises components that interact with a user. User interface 602 may include a keyboard, display screen, mouse, touch pad, or some other user input/output apparatus. User interface 602 may be omitted in some examples.

Processing circuitry 605 comprises microprocessor and other circuitry that retrieves and executes operating software 607 from memory device 606. Memory device 606 comprises a non-transitory storage medium, such as a disk drive, flash drive, data storage circuitry, or some other memory apparatus. Operating software 607 comprises computer programs, firmware, or some other form of machine-readable processing instructions. Operating software 607 includes calendar management module 608 and entry conversion module 609. Operating software 607 may further include an operating system, utilities, drivers, network interfaces, applications, or some other type of software. When executed by circuitry 605, operating software 607 directs processing system 603 to operate multi-calendar system 600 as described herein.

In particular, calendar management module 608 directs processing system 603 to identify at least one calendar entry for a first calendar of a first calendar service of the plurality of calendar services. Entry conversion module 609 directs processing system 603 to convert the at least one calendar entry into at least one placeholder calendar entry for a second calendar of a second calendar service of the plurality of calendar services. Calendar management module 608 further directs processing system 603 to insert the at least one placeholder calendar entry into the second calendar.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for indicating calendar entries across a plurality of calendar services, the method comprising:
identifying at least one calendar entry for a first calendar of a first calendar service of the plurality of calendar services;
converting the at least one calendar entry into at least one placeholder calendar entry for a second calendar of a second calendar service of the plurality of calendar services; and
inserting the at least one placeholder calendar entry into the second calendar.

2. The method of claim 1, further comprising:
converting the at least one calendar entry into at least one second placeholder calendar entry for a third calendar of a third calendar service of the plurality of calendar services; and
inserting the at least one second placeholder calendar entry into the third calendar.

3. The method of claim 1, further comprising:
identifying at least one second calendar entry for the second calendar;
converting the at least one second calendar entry into at least one second placeholder calendar entry for the first calendar; and
inserting the at least one second placeholder calendar entry into the first calendar.

4. The method of claim 1, wherein converting the at least one calendar entry comprises:
copying the at least one calendar entry to create the at least one placeholder entry.

5. The method of claim 1, wherein converting the at least one calendar entry comprises:
determining at least one time frame corresponding to the at least one calendar entry for blocking off in the second calendar.

6. The method of claim 5, wherein inserting the at least one placeholder calendar entry into the second calendar comprises:
blocking off the at least one time frame in the second calendar.

7. The method of claim 1, wherein converting the at least one calendar entry comprises:
mapping information in first elements of the at least one calendar entry in a format of the first calendar into corresponding second elements of the at least one placeholder calendar entry in a format of the second calendar.

8. The method of claim 1, wherein mapping the information comprises:
adjusting the information to account for when a corresponding element of the second elements does not directly correspond.

9. The method of claim 1, wherein the at least one placeholder calendar entry indicates to a user that the at least one placeholder calendar entry did not originate in the second calendar.

10. The method of claim 9, wherein the at least one placeholder calendar entry indicates to the user that the at least one placeholder calendar entry originated in the first calendar.

11. A multi-calendar system to indicate calendar entries across a plurality of calendar services, the multi-calendar system comprising:
one or more computer readable storage media;
a processing system operatively coupled with the one or more computer readable storage media; and
program instructions stored on the one or more computer readable storage media that, when read and executed by the processing system, direct the processing system to:
identify at least one calendar entry for a first calendar of a first calendar service of the plurality of calendar services;
convert the at least one calendar entry into at least one placeholder calendar entry for a second calendar of a second calendar service of the plurality of calendar services; and
insert the at least one placeholder calendar entry into the second calendar.

12. The multi-calendar system of claim 11, wherein the program instructions further direct the processing system to:
convert the at least one calendar entry into at least one second placeholder calendar entry for a third calendar of a third calendar service of the plurality of calendar services; and
insert the at least one second placeholder calendar entry into the third calendar.

13. The multi-calendar system of claim 11, wherein the program instructions further direct the processing system to:
identify at least one second calendar entry for the second calendar;
convert the at least one second calendar entry into at least one second placeholder calendar entry for the first calendar; and
insert the at least one second placeholder calendar entry into the first calendar.

14. The multi-calendar system of claim 11, wherein to convert the at least one calendar entry, the program instructions direct the processing system to at least:
copy the at least one calendar entry to create the at least one placeholder entry.

15. The multi-calendar system of claim 11, wherein to convert the at least one calendar entry, the program instructions direct the processing system to at least:
determine at least one time frame corresponding to the at least one calendar entry for blocking off in the second calendar.

16. The multi-calendar system of claim 15, wherein to insert the at least one placeholder calendar entry into the second calendar, the program instructions direct the processing system to at least:
blocking off the at least one time frame in the second calendar.

17. The multi-calendar system of claim 11, wherein to convert the at least one calendar entry, the program instructions direct the processing system to at least:
map information in first elements of the at least one calendar entry in a format of the first calendar into corresponding second elements of the at least one placeholder calendar entry in a format of the second calendar.

18. The multi-calendar system of claim 11, wherein to map the information, the program instructions direct the processing system to at least:
adjust the information to account for when a corresponding element of the second elements does not directly correspond.

19. The multi-calendar system of claim 11, wherein the at least one placeholder calendar entry indicates to a user that the at least one placeholder calendar entry did not originate in the second calendar.

20. The multi-calendar system of claim 19, wherein the at least one placeholder calendar entry indicates to the user that the at least one placeholder calendar entry originated in the first calendar.
